(19) United States
(12) Patent Application Publication
(10) Pub. No.: US 2024/0381267 A1
(43) Pub. Date: Nov. 14, 2024

(54) IMPLICIT INDICATION OF TRANSMISSION POWER LEVEL FOR CHANNEL STATE INFORMATION REFERENCE SIGNALS

(71) Applicant: QUALCOMM Incorporated, San Diego, CA (US)

(72) Inventors: Ahmed Attia ABOTABL, San Diego, CA (US); Hung Dinh LY, San Diego, CA (US)

(21) Appl. No.: 18/416,992

(22) Filed: Jan. 19, 2024

Related U.S. Application Data
(60) Provisional application No. 63/465,800, filed on May 11, 2023.

(51) Int. Cl. H04W 52/24; H04B 7/06

(52) U.S. Cl. CPC H04W 52/241; H04B 7/0626

(57) ABSTRACT

Certain aspects of the present disclosure provide techniques for implicitly indicating transmission power level for channel state information (CSI) reference signals, such as may be used for channel sounding procedures. A method includes receiving a first CSI reference resource indicating a CSI reference signal (CSI-RS) transmission power level, receiving one or more CSI measurement resources during an implicit indication interval beginning with the CSI reference resource and ending with an uplink resource configured for sending a channel state metric, and determining the channel state metric based on the CSI-RS transmission power level and at least one of the one or more CSI measurement resources.

### CROSS-REFERENCE TO RELATED APPLICATION

This application claims the benefit of and priority to U.S. Provisional Application No. 63/465,800 filed on May 11, 2023, the disclosure of which is incorporated herein by reference in its entirety.

### INTRODUCTION

### Field of the Disclosure

Aspects of the present disclosure relate to wireless communications, and more particularly, to techniques for implicitly indicating transmission power level for channel state information reference signals.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a user equipment (UE). The method includes receiving a channel state information (CSI) reference resource indicating a CSI reference signal (CSI-RS) transmission power level; receiving one or more CSI measurement resources during an implicit indication interval beginning with the CSI reference resource and ending with an uplink resource configured for sending a channel state metric; and determining a channel state metric based on the CSI-RS transmission power level and at least one of the one or more CSI measurement resources, wherein the CSI reference resource implicitly indicates to the user equipment that the CSI-RS transmission power level applies to all of the one or more CSI measurement resources.

Another aspect provides a method for wireless communications by a network entity. The method includes sending, to a user equipment, a CSI reference resource indicating a CSI-RS transmission power level; sending, to the user equipment, one or more CSI measurement resources during an implicit indication interval beginning with the CSI reference resource and ending with an uplink resource configured for receiving a channel state metric; and receiving, from the user equipment via the uplink resource, a channel state metric, wherein the CSI reference resource is configured to implicitly indicate to the user equipment that the CSI-RS transmission power level applies to all of the one or more CSI measurement resources.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5A depicts an example of implicitly indicating transmission power levels for CSI-RS.

FIG. 5B depicts another example of implicitly indicating transmission power levels for CSI-RS.

FIG. 6 depicts another example of implicitly indicating transmission power levels for CSI-RS.

FIG. 7 depicts a method for wireless communications.

FIG. 8 depicts another method for wireless communications.

FIG. 9 depicts aspects of an example communications device.

FIG. 10 depicts aspects of an example communications device.

### DETAILED DESCRIPTION

Aspects of the present disclosure provide apparatuses, methods, processing systems, and computer-readable mediums for implicitly indicating transmission power level for channel state information reference signals, such as may be used for channel sounding procedures.

As wireless communication systems grow in ubiquity and capability, so too do the energy demands of such systems. In particular, often more than half of the energy consumed by a wireless communication system (e.g. a cellular network) is related to the radio access network (RAN) that provides access to and data information exchange between the core network and devices connecting to the network via transmitted and received radio signals. Reducing the energy consumed by wireless communication systems has many beneficial technical effects, such as improved energy efficiency, improved spectrum efficiency, reduced interference, improved sustainability, expanded deployment potential, and others.

One method of improving energy efficiency of a wireless communication system is by spatial adaptation in which, for example, antenna ports, antenna elements, and/or combinations of antenna ports and antenna elements (referred to as spatial patterns) are selectively deactivated to save transmission power. To support spatial adaptation, user equipments may be configured with multiple channel state information (CSI) reporting configurations (e.g., CSI-ReportConfig) for different spatial patterns. Generally, a CSI reporting configuration may define one or more CSI-RS resource sets (e.g., NZP-CSI-RSResourceSets), which include one or more individual CSI measurement resources (e.g., NZP-CSI-RS).

Another method of improving energy efficiency is by power adaptation in which the transmission power level of, for example, a reference signal may be selectively reduced to reduce energy consumption. In one example, to implement power adaptation, a power offset value (e.g., between a CSI reference signal (CSI-RS) and a physical downlink shared channel) may be changed, such as through radio resource control (RRC) signaling.

Both spatial and power adaptation (e.g., in combination) may be implemented by a wireless communication system to further reduce energy consumption by the system. However, when implementing spatial adaptation, power adaptation, or both, consideration must be given to the amount of communication system (e.g., network) overhead necessary to explicitly signal the adaptations.

For example, measurement of specific CSI-RS is explicitly configured for specific user equipments, such as to support channel state determination, beam management, and mobility, among other things. In other words, a user equipment generally does not make assumptions regarding the presence or configuration of a CSI-RS unless the CSI-RS is explicitly configured for the user equipment. Thus, when an adaptation is made to a CSI-RS, it too must be configured for a user equipment via explicit signaling.

For example, when applying spatial adaptation to a CSI-RS to reduce energy consumption (e.g., by reducing a number of ports and/or antenna elements used for transmission of the CSI-RS), the configuration change associated with the adaptation needs to be signaled to any user equipment receiving the CSI-RS. Given the large number of potential spatial patterns, a large number of CSI-RS resource and reporting configurations may need signaling.

As another example, CSI-RS resource and report configuration signaling overhead scales with the number of power control offset values being implemented by a wireless communication system for power adaptation. Thus, when power adaptations are being performed dynamically (and frequently) based on multiple power control offsets for CSI-RS transmitted to a large number of user equipments, the overhead may increase significantly.

In both of the preceding examples, a technical problem arises in that the energy saving benefits of the adaptations can be mitigated by the overhead necessary (e.g., in terms of explicit signaling) to implement the adaptations.

To overcome the aforementioned technical problem, aspects described herein are directed to implicitly (rather than explicitly) indicating CSI-RS transmission power level changes for CSI measurement resources received by user equipments. The implicit indications have the beneficial technical effect of reducing the signaling overhead while maintaining the ability to implement energy saving adaptations.

For example, in one aspect, a user equipment initially receives a CSI reference resource (e.g., such as defined by 3GPP TS 38.214-5.2.21) that explicitly indicates a CSI-RS transmission power level. Next, the user equipment receives one or more CSI measurement resources (e.g., a set of CSI measurement resources) during an implicit indication interval beginning with the CSI reference resource and ending with an uplink resource configured for sending a channel state metric (e.g., to a network entity). Finally, the user equipment determines a channel state metric based on the CSI-RS transmission power level (explicitly indicated by the CSI reference resource) and at least one of the one or more CSI measurement resources. Notably, the user equipment assumes the transmission power level for each of the CSI measurement resources is the same as that set by the CSI reference resource during the implicit indication interval. In other words, the user equipment may assume the same NZP-CSI-RS configuration for measurement resources between the CSI reference resource and the uplink resource configured for receiving the CSI. In this way, the transmission power level of the CSI measurement resource in each of the measurement occasions between the CSI reference resource and the uplink resource for reporting the CSI is implicitly indicated to the user equipment without the need for explicit signaling from a network entity. Thus, the beneficial technical effect of this implicit signaling is a reduction in signaling overhead, which reduces the energy consumption of the network because less signaling needs to be sent, and reduces the energy consumption of the user equipment because less signaling needs to be received and processed.

In some aspects the user equipment may be configured to assume only a subset of the CSI measurement resources (e.g., during an implicit indication time interval defined by the CSI reference resource and the uplink resource configured for receiving the CSI) use the same NZP-CSI-RS configuration.

For example, the subset of CSI measurement resources may be (pre) configured as some number, n, of CSI measurement resources (or measurement occasions) before an uplink slot in which the user equipment is configured to report measurements and/or channel state metrics determined based on the metrics (e.g., L1-RSRP or L1-SINR or CSI parameters). In some aspects, n is defined in a specification (e.g., 3GPP) or indicated in system information (SI) or RRC signaling. For example, if the set of CSI measurement resources during the implicit indication interval is {M₁, M₂, M₃, M₄} and n=2, then the user equipment may assume that the NZP-CSI-RS for the CSI reference resource is the same for M₃ and M₄.

As another example, a specific subset of CSI measurement resources may be indicated to the user equipment, such as via RRC, L1, or L2 signaling from a network entity. Returning to the example of a set of CSI measurement resources {M₁, M₂, M₃, M₄}, a subset including, for example, {M₁ and M₃} may be explicitly indicated to the user equipment.

In the preceding examples, the user equipment may be configured without time restriction for measuring channel state information, such as when a timeRestrictionForChannelMeasurements information element in a CSI-ReportConfig is set to “notConfigured.” However, in other aspects, a CSI report may be configured with time restriction, such as when the timeRestrictionForChannelMeasurements information element in the CSI-ReportConfig is set to “configured.” In such cases, the user equipment may determine the channel state metric based on the most recent CSI measurement resource of the set prior to the uplink slot configured for sending the CSI and based on the transmit power level set for the CSI reference resource.

Aspects described herein may thus be used to reduce network and user equipment power consumption by reducing the need for explicit signaling while maintaining the ability to implement complementary energy saving techniques, such as spatial and power adaptation of CSI-RS. Thus, aspects described herein provide a technical solution to the energy consumption problem discussed above.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

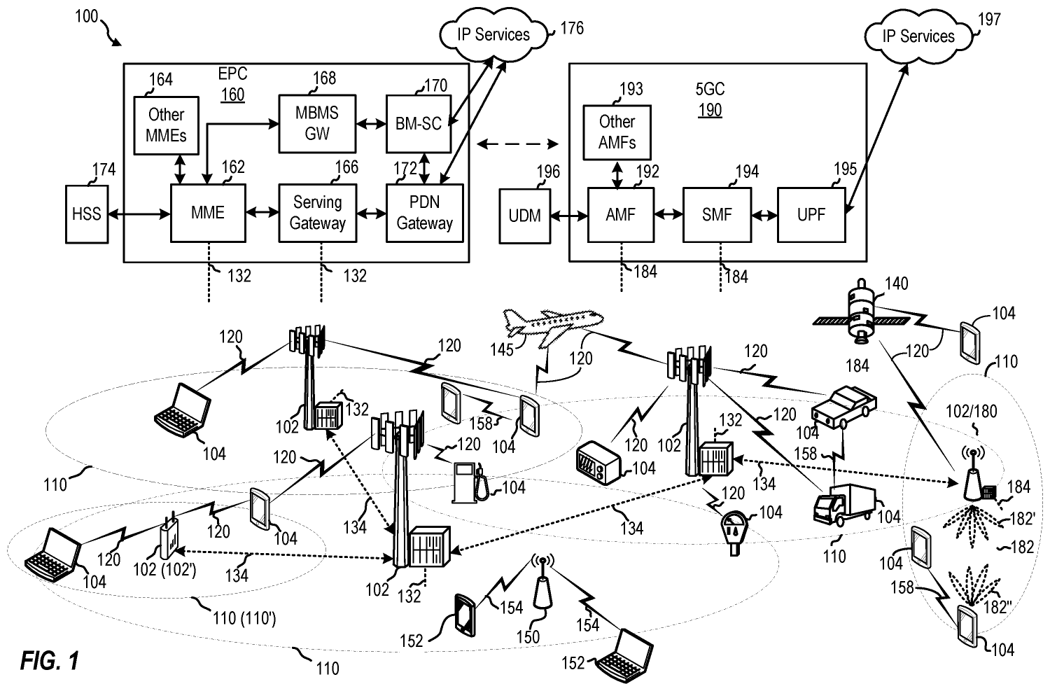

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such, communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

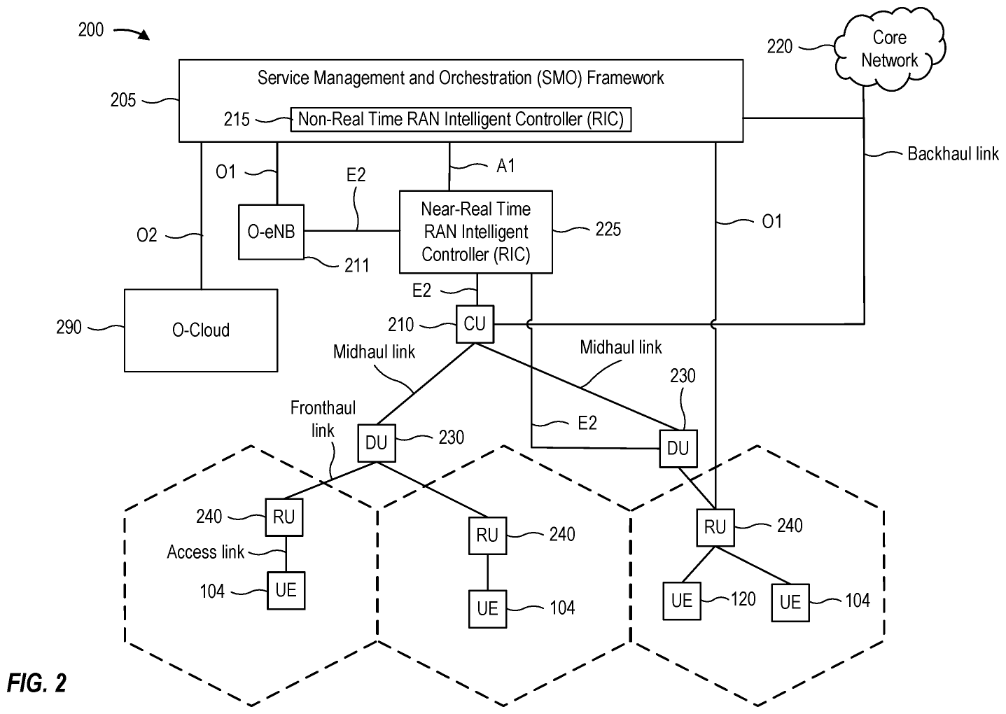

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an SI interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHZ, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

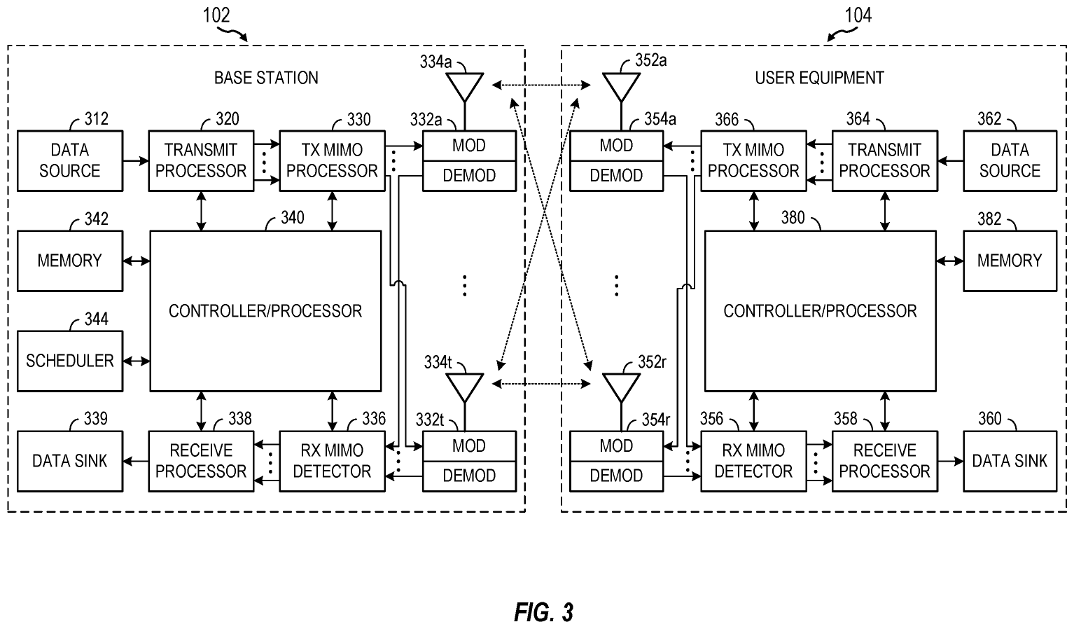

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

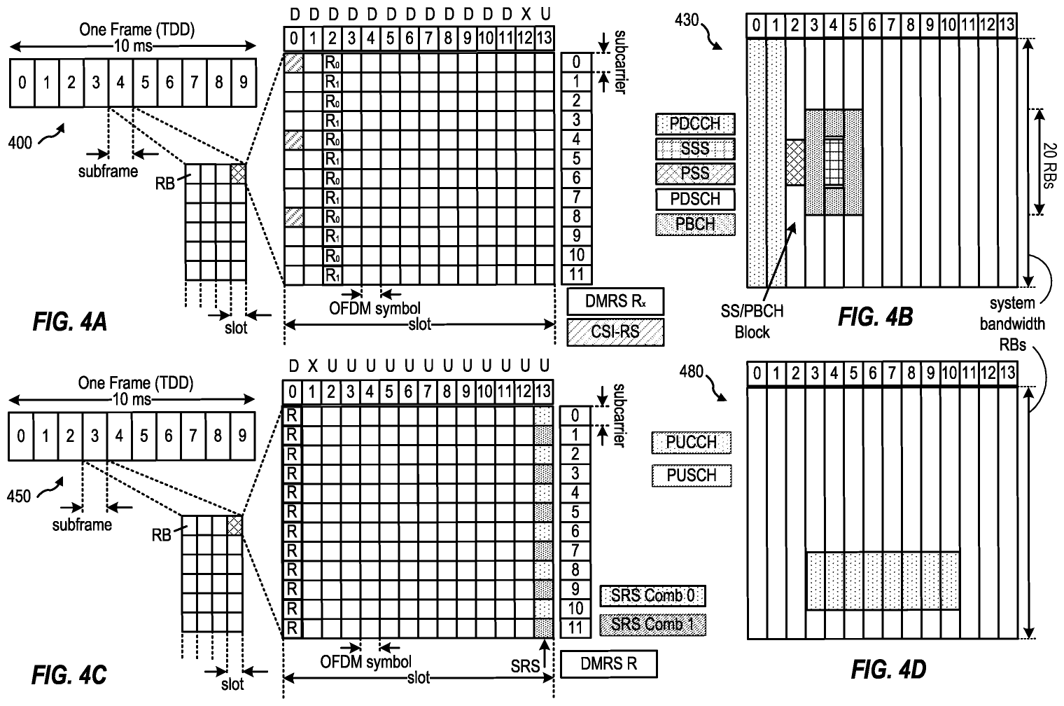

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Implicitly Indicating Transmission Power Level for Channel State Information Reference Signals

For a UE to determine CSI based on a received CSI-RS, it must know the transmission power level used by a network entity to transmit the CSI-RS. This transmission power level is generally configured for CSI measurement resources by the network and may change from one measurement occasion to another, such as in the case of dynamic spatial and/or power adaptation. To reduce network signaling overhead, a UE may be configured to assume that the transmission power level for a certain set of CSI measurement resources is the same as that of a CSI reference resource in order that additional signaling for that set of CSI measurement resources is avoided and network energy consumption is beneficially reduced. In such cases, it may be said that the transmission power level for the set of CSI measurement resources is implicitly indicated by the CSI reference resource for the CSI measurement resources.

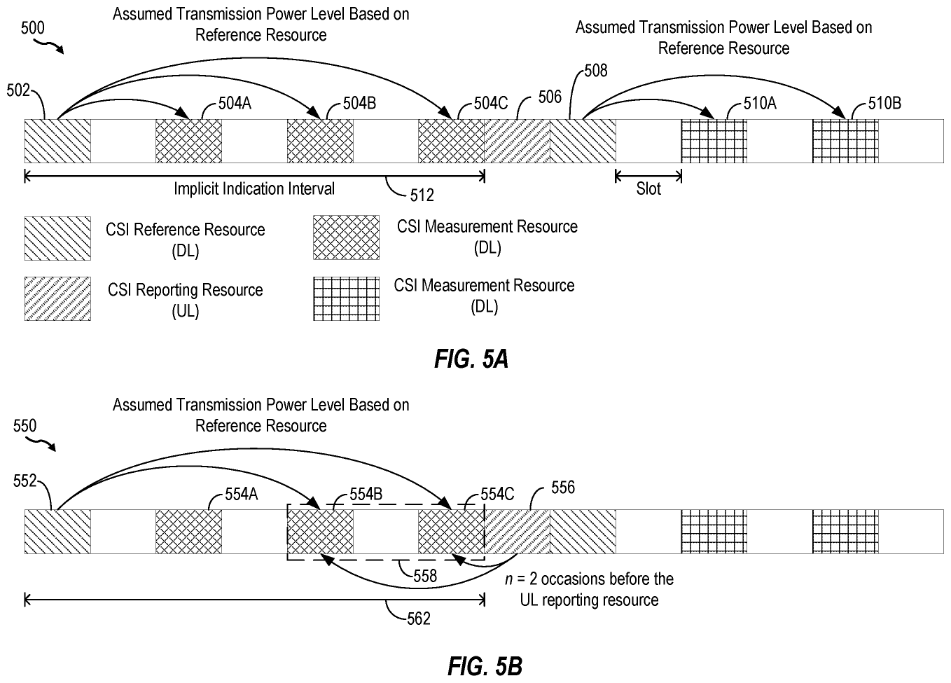

FIG. 5A depicts an example 500 of implicitly indicating transmission power levels for CSI-RS. In particular, a UE receives a CSI reference resource within slot 502 indicating a transmission power level for a set of CSI measurement resources that will occur prior to the uplink slot (506) scheduled for reporting the CSI, which in this example includes the CSI measurement resources scheduled for slots 504A-C. When measuring the CSI measurement resources in slots 504A-C, the user equipment will assume that the transmission power level is the same as that configured for the CSI reference resource within slot 502, and thus no additional signaling is necessary to be sent by a network entity or received by a user equipment with regard to the CSI measurement resources in slots 504A-C. The transmission power level for the CSI measurement resources in slots 504A-C are implicitly indicated to the UE via the CSI reference resource in slot 502. Thus, an implicit indication interval 512 may be defined as beginning at the time (e.g., with the slot) in which a CSI reference resource is received, and ending in the last slot before a slot configured for reporting the measurements and/or a channel state metric based on one or more CSI measurements resources received within the implicit indication interval.

The UE reports the CSI (e.g., measurements and/or a channel state metrics, such as L1-RSRP or L1-SINR, or CSI parameters, like channel-quality indicator (CQI), rank indicator (RI), and precoder-matrix indicator (PMI)) in uplink slot 506. Thereafter, the UE receives a new CSI reference resource at slot 508, which in this example indicates a new transmission power level to be used for CSI measurement resources in slots 510A-B.

Note that while entire slots are patterned in FIG. 5A to show when CSI reference, measurement, and reporting resources are scheduled, this is not meant to indicate that such resources occupy the entire slot. Rather, each such resource may occupy some number of resource elements within the slots. That patterning is merely for convenient visual reference.

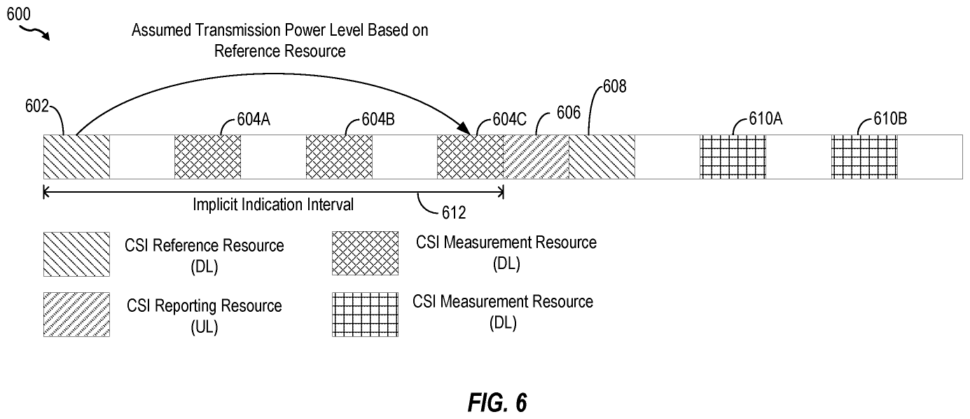

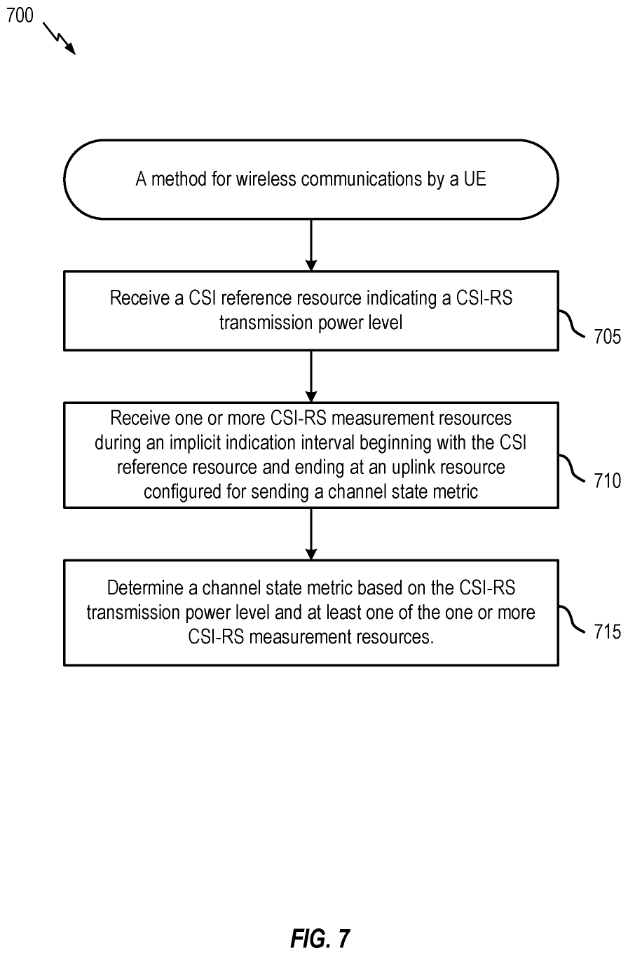

Example 500 may be implemented, for example, to perform channel state measurement when a UE is configured for spatial adaptation and/or power adaptation, such as described below with respect to FIG. 7. Note that in example 500, the UE is not configured with time restriction for channel measurement. For example, timeRestrictionForChannelMeasurements in a CSI-ReportConfig utilized by the UE is set to “notConfigured” in this example. FIG. 6 describes an example in which time restriction is enabled for the UE.

FIG. 5B depicts another example 550 of implicitly indicating transmission power levels for CSI-RS. In this example, like example 500, a UE receives a CSI reference resource within slot 552 indicating a transmission power level for a set CSI measurement resources that will occur prior to the uplink slot (556) scheduled for reporting the measurements, which in this example includes the CSI measurement resources scheduled for slots 554A-C within implicit indication interval 562. However, in this example, the UE assumes the transmission power level for only a subset 558 of the CSI measurement resources occurring within the implicit indication interval 562 use the same transmission power level. In the depicted example, the subset 558 includes the measurement resources within slots 554B-C, but not within slot 554A.

The subset of CSI measurement resources may be defined in various ways. As a first example, the subset of CSI measurement resources may be configured as including a number of occasions (or resources), n, before the uplink slot in which the UE reports the CSI (here, slot 556). For example, in FIG. 5B, n=2 occasions before the uplink reporting resource in slot 556 and thus includes the CSI measurement resources within slots 554B-C. This is a form of indirect or referential definition of the subset of CSI measurement resources. In some aspects, n can be defined in a specification (e.g., 3GPP) or signaled in system (SI) or via RRC.

As another example, the subset of CSI measurement resources may be explicitly indicated to the UE, such as by RRC, L1 (e.g., DCI), or L2 signaling (e.g., MAC-CE). So, for example, a network entity could directly define subset 558 as including the CSI measurement resources within slots 554B and 55C rather than by reference to some other resource.

As with example 500, here the UE reports the measurements and/or a channel state metric based on the measurements in uplink slot 556.

FIG. 6 depicts another example 600 of implicitly indicating transmission power levels for CSI-RS. However, in this example, unlike those of FIGS. 5A and 5B, assume that time restriction for channel measurement is configured (i.e., the timeRestrictionForChannelMeasurements information element in a CSI-ReportConfig for the UE is set to “Configured.”

In this example, the UE receives a CSI reference resource within slot 602 indicating a transmission power level for a set CSI measurement resources that will occur prior to the uplink slot (606) scheduled for reporting the CSI, which in this example includes the CSI measurement resources scheduled for slots 604A-C within implicit indication interval 612. However, in this example, because time restriction is configured, the UE assumes the transmission power level is the same as that of the CSI reference resource (in slot 602) only for the last (in time) CSI measurement resource (604C) within the implicit indication interval 612.

Thereafter, the UE receives a new CSI reference resource at slot 608, which in this example indicates a new transmission power level to be used for CSI measurement resources in slots 610A-B.

### Example Operations by a User Equipment

FIG. 7 shows a method 700 for wireless communications by a UE, such as UE 104 of FIGS. 1 and 3.

Method 700 begins at step 705 with receiving a CSI reference resource indicating a CSI-RS transmission power level.

Method 700 then proceeds to step 710 with receiving one or more CSI measurement resources during an implicit indication interval beginning with the CSI reference resource and ending with an uplink resource configured for sending a channel state metric (e.g., based on one or more of the CSI measurement resource).

Method 700 then proceeds to step 715 with determining the channel state metric based on the CSI-RS transmission power level and at least one of the one or more CSI measurement resources, wherein the CSI reference resource implicitly indicates to the user equipment that the CSI-RS transmission power level applies to all of the one or more CSI measurement resources (such as described above with respect to FIGS. 5A, 5B, and 6).

In one aspect, the CSI reference resource further indicates that time restriction for channel measurement is not configured (such as described above with respect to FIGS. 5A and 5B).

In one aspect, method 700 further includes determining the channel state metric based on the CSI-RS transmission power level and each of the one or more CSI measurement resources (such as described above with respect to FIG. 5A).

In one aspect, method 700 further includes determining the channel state metric based on a subset of the one or more CSI measurement resources (such as described above with respect to FIG. 5B).

In one aspect, the subset comprises a number of CSI measurement resources (or occasions) before an uplink slot configured for reporting the channel state metric (such as described above with respect to FIG. 5B).

In one aspect, method 700 further includes receiving an indication of the number of CSI measurement resources (or occasions) before the uplink slot.

In one aspect, method 700 further includes receiving the indication via system information or RRC signaling.

In one aspect, method 700 further includes receiving an indication of the subset of the one or more CSI measurement resources (such as described above with respect to FIG. 5B).

In one aspect, method 700 further includes receiving the indication via RRC signaling or via one of layer 1 or layer 2 signaling.

In one aspect, the CSI reference resource further indicates that time restriction for channel measurement is configured, and the method 700 further comprises determining the channel state metric based on the CSI-RS transmission power level and a latest CSI-RS measurement resource of the one or more CSI measurement resources (such as described above with respect to FIG. 6).

In one aspect, the channel state metric comprises one or more of: a RSRP value; a RSRQ value; or a SINR value.

In one aspect, method 700 further includes performing one or more of the following based on the channel state metric: beam management; radio link failure detection; beam failure detection; time and frequency synchronization; or connected mode mobility.

In one aspect, method 700 further includes sending, to a network entity, the channel state metric.

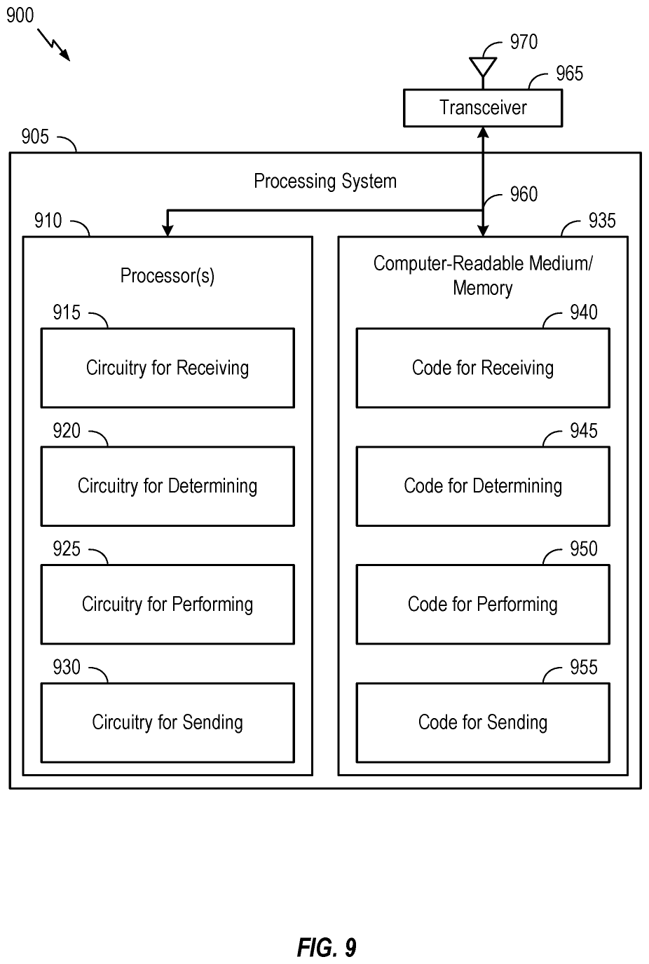

In one aspect, method 700, or any aspect related to it, may be performed by an apparatus, such as communications device 900 of FIG. 9, which includes various components operable, configured, or adapted to perform the method 700. Communications device 900 is described below in further detail.

Note that FIG. 7 is just one example of a method, and other methods including fewer, additional, or alternative steps are possible consistent with this disclosure.

### Example Operations by a Network Entity

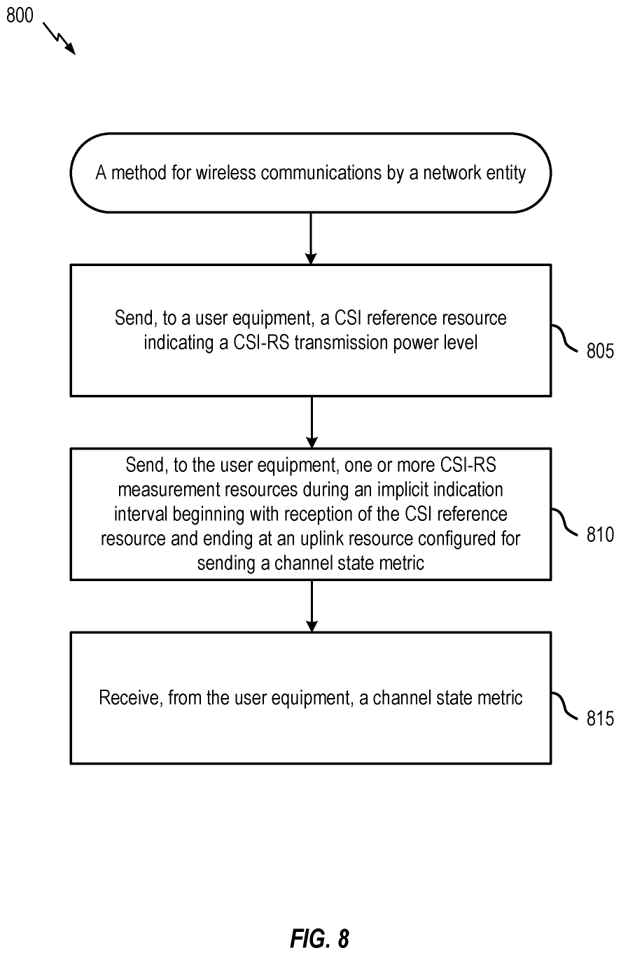

FIG. 8 shows a method 800 for wireless communications by a network entity, such as BS 102 of FIGS. 1 and 3, or a disaggregated base station as discussed with respect to FIG. 2.

Method 800 begins at step 805 with sending, to a user equipment, a CSI reference resource indicating a CSI-RS transmission power level.

Method 800 then proceeds to step 810 with sending, to the user equipment, one or more CSI measurement resources during an implicit indication interval beginning with the CSI reference resource and ending with an uplink resource configured for receiving a channel state metric.

Method 800 then proceeds to step 815 with receiving, from the user equipment via the uplink resource, a channel state metric, wherein the CSI reference resource is configured to implicitly indicate to the user equipment that the CSI-RS transmission power level applies to all of the one or more CSI measurement resources.

In one aspect, the CSI reference resource further indicates that time restriction for channel measurement is not configured.

In one aspect, the channel state metric is based on the CSI-RS transmission power level and each of the one or more CSI measurement resources.

In one aspect, the channel state metric is based on a subset of the one or more CSI measurement resources.

In one aspect, the subset comprises a number of CSI measurement resources (or occasions) before the uplink slot configured for reporting the channel state metric.

In one aspect, method 800 further includes sending, to the user equipment, an indication of the number of CSI measurement resources (or occasions) before the uplink slot.

In one aspect, method 800 further includes sending the indication via system information or RRC signaling.

In one aspect, method 800 further includes sending, to the user equipment, an indication of the subset of the one or more CSI measurement resources.

In one aspect, method 800 further includes sending the indication via RRC signaling or via one of layer 1 or layer 2 signaling.

In one aspect, the CSI reference resource further indicates that time restriction for channel measurement is configured, and the channel state metric is based on the CSI-RS transmission power level and a latest CSI-RS measurement resource of the one or more CSI measurement resources.

In one aspect, the channel state metric comprises one or more of: a RSRP value; a RSRQ value; or a SINR value.

In one aspect, method 800 further includes performing one or more of the following based on the channel state metric: beam management; radio link failure detection; beam failure detection; time and frequency synchronization; or connected mode mobility.

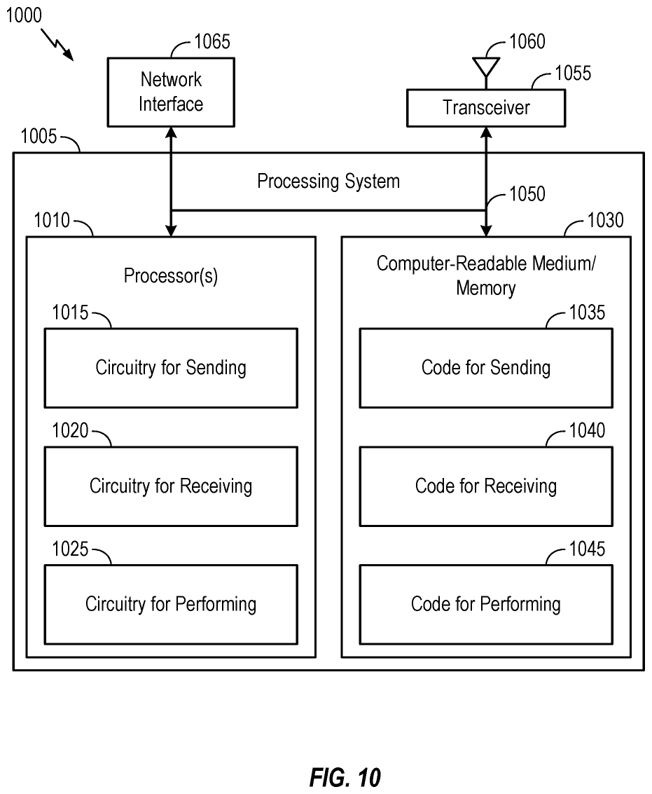

In one aspect, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative steps are possible consistent with this disclosure.

### Example Communications Devices

FIG. 9 depicts aspects of an example communications device 900. In some aspects, communications device 900 is a user equipment, such as UE 104 described above with respect to FIGS. 1 and 3.

The communications device 900 includes a processing system 905 coupled to a transceiver 965 (e.g., a transmitter and/or a receiver). The transceiver 965 is configured to transmit and receive signals for the communications device 900 via an antenna 970, such as the various signals as described herein. The processing system 905 may be configured to perform processing functions for the communications device 900, including processing signals received and/or to be transmitted by the communications device 900.

The processing system 905 includes one or more processors 910. In various aspects, the one or more processors 910 may be representative of one or more of receive processor 358, transmit processor 364, TX MIMO processor 366, and/or controller/processor 380, as described with respect to FIG. 3. The one or more processors 910 are coupled to a computer-readable medium/memory 935 via a bus 960. In certain aspects, the computer-readable medium/memory 935 is configured to store instructions (e.g., computer-executable code) that when executed by the one or more processors 910, enable and cause the one or more processors 910 to perform the method 700 described with respect to FIG. 7, or any aspect related to it, including any additional steps or sub-steps described in relation to FIG. 7. Note that reference to a processor performing a function of communications device 900 may include one or more processors performing that function of communications device 900, such as in a distributed fashion.

In the depicted example, computer-readable medium/memory 935 stores code for receiving 940, code for determining 945, code for performing 950, and code for sending 955. Processing of the code 940-955 may enable and cause the communications device 900 to perform the method 700 described with respect to FIG. 7, or any aspect related to it.

The one or more processors 910 include circuitry configured to implement (e.g., execute) the code stored in the computer-readable medium/memory 935, including circuitry for receiving 915, circuitry for determining 920, circuitry for performing 925, and circuitry for sending 930. Processing with circuitry 915-930 may enable and cause the communications device 900 to perform the method 700 described with respect to FIG. 7, or any aspect related to it.

More generally, means for communicating, transmitting, sending or outputting for transmission may include the transceivers 354, antenna(s) 352, transmit processor 364, TX MIMO processor 366, and/or controller/processor 380 of the UE 104 illustrated in FIG. 3, transceiver 965 and/or antenna 970 of the communications device 900 in FIG. 9, and/or one or more processors 910 of the communications device 900 in FIG. 9. Means for communicating, receiving or obtaining may include the transceivers 354, antenna(s) 352, receive processor 358, and/or controller/processor 380 of the UE 104 illustrated in FIG. 3, transceiver 965 and/or antenna 970 of the communications device 900 in FIG. 9, and/or one or more processors 910 of the communications device 900 in FIG. 9.

FIG. 10 depicts aspects of an example communications device. In some aspects, communications device 1000 is a network entity, such as BS 102 of FIGS. 1 and 3, or a disaggregated base station as discussed with respect to FIG. 2.

The communications device 1000 includes a processing system 1005 coupled to a transceiver 1055 (e.g., a transmitter and/or a receiver) and/or a network interface 1065. The transceiver 1055 is configured to transmit and receive signals for the communications device 1000 via an antenna 1060, such as the various signals as described herein. The network interface 1065 is configured to obtain and send signals for the communications device 1000 via communications link(s), such as a backhaul link, midhaul link, and/or fronthaul link as described herein, such as with respect to FIG. 2. The processing system 1005 may be configured to perform processing functions for the communications device 1000, including processing signals received and/or to be transmitted by the communications device 1000.

The processing system 1005 includes one or more processors 1010. In various aspects, one or more processors 1010 may be representative of one or more of receive processor 338, transmit processor 320, TX MIMO processor 330, and/or controller/processor 340, as described with respect to FIG. 3. The one or more processors 1010 are coupled to a computer-readable medium/memory 1030 via a bus 1050. In certain aspects, the computer-readable medium/memory 1030 is configured to store instructions (e.g., computer-executable code) that when executed by the one or more processors 1010, enable and cause the one or more processors 1010 to perform the method 800 described with respect to FIG. 8, or any aspect related to it, including any additional steps or sub-steps described in relation to FIG. 8. Note that reference to a processor of communications device 1000 performing a function may include one or more processors of communications device 1000 performing that function, such as in a distributed fashion.

In the depicted example, the computer-readable medium/memory 1030 stores code for sending 1035, code for receiving 1040, and code for performing 1045. Processing of the code 1035-1045 may enable and cause the communications device 1000 to perform the method 800 described with respect to FIG. 8, or any aspect related to it.

The one or more processors 1010 include circuitry configured to implement (e.g., execute) the code stored in the computer-readable medium/memory 1030, including circuitry for sending 1015, circuitry for receiving 1020, and circuitry for performing 1025. Processing with circuitry 1015-1025 may enable and cause the communications device 1000 to perform the method 800 described with respect to FIG. 8, or any aspect related to it.

More generally, means for communicating, transmitting, sending or outputting for transmission may include the transceivers 332, antenna(s) 334, transmit processor 320, TX MIMO processor 330, and/or controller/processor 340 of the BS 102 illustrated in FIG. 3, transceiver 1055 and/or antenna 1060 of the communications device 1000 in FIG. 10, and/or one or more processors 1010 of the communications device 1000 in FIG. 10. Means for communicating, receiving or obtaining may include the transceivers 332, antenna(s) 334, receive processor 338, and/or controller/processor 340 of the BS 102 illustrated in FIG. 3, transceiver 1055 and/or antenna 1060 of the communications device 1000 in FIG. 10, and/or one or more processors 1010 of the communications device 1000 in FIG. 10.

### Example Clauses

Implementation examples are described in the following numbered clauses:

Clause 1: A method for wireless communications by a UE comprising: receiving a CSI reference resource indicating a CSI-RS transmission power level; receiving one or more CSI measurement resources during an implicit indication interval beginning with the CSI reference resource and ending with an uplink resource configured for sending a channel state metric; and determining a channel state metric based on the CSI-RS transmission power level and one or more of the one or more CSI measurement resources, wherein the CSI reference resource implicitly indicates to the user equipment that the CSI-RS transmission power level applies to all of the one or more CSI measurement resources.

Clause 2: The method of Clause 1, wherein the CSI reference resource further indicates that time restriction for channel measurement is not configured.

Clause 3: The method of Clause 2, further comprising determining the channel state metric based on the CSI-RS transmission power level and each of the one or more CSI measurement resources.

Clause 4: The method of Clause 2, further comprising determining the channel state metric based on a subset of the one or more CSI measurement resources.

Clause 5: The method of Clause 4, wherein the subset comprises a number of CSI measurement resources before the uplink resource configured for reporting the channel state metric.

Clause 6: The method of Clause 5, further comprising receiving an indication of the number of CSI measurement resources before the uplink resource configured for reporting the channel state metric.

Clause 7: The method of Clause 6, further comprising receiving the indication via system information or RRC signaling.

Clause 8: The method of Clause 4, further comprising receiving an indication of the subset of the one or more CSI measurement resources.

Clause 9: The method of Clause 8, further comprising receiving the indication via RRC signaling or via one of layer 1 or layer 2 signaling.

Clause 10: The method of any one of Clauses 1-9, wherein: the CSI reference resource further indicates that time restriction for channel measurement is configured, and the method further comprises determining the channel state metric based on the CSI-RS transmission power level and a latest CSI-RS measurement resource of the one or more CSI measurement resources.

Clause 11: The method of any one of Clauses 1-10, wherein the channel state metric comprises one or more of: a RSRP value; a RSRQ value; or a SINR value.

Clause 12: The method of any one of Clauses 1-11, further comprising performing one or more of the following based on the channel state metric: beam management; radio link failure detection; beam failure detection; time and frequency synchronization; or connected mode mobility.

Clause 13: The method of any one of Clauses 1-12, further comprising sending, to a network entity, the channel state metric.

Clause 14: A method for wireless communications by a network entity comprising: sending, to a user equipment, a CSI reference resource indicating a CSI-RS transmission power level; sending, to the user equipment, one or more CSI measurement resources during an implicit indication interval beginning with the CSI reference resource and ending with an uplink resource configured for receiving a channel state metric; and receiving, from the user equipment via the uplink resource, a channel state metric, wherein the CSI reference resource is configured to implicitly indicate to the user equipment that the CSI-RS transmission power level applies to all of the one or more CSI measurement resources.

Clause 15: The method of Clause 14, wherein the CSI reference resource further indicates that time restriction for channel measurement is not configured.

Clause 16: The method of Clause 15, wherein the channel state metric is based on the CSI-RS transmission power level and each of the one or more CSI measurement resources.

Clause 17: The method of Clause 15, wherein the channel state metric is based on a subset of the one or more CSI measurement resources.

Clause 18: The method of Clause 17, wherein the subset comprises a number of CSI measurement resources before the uplink resource configured for reporting the channel state metric.

Clause 19: The method of Clause 18, further comprising sending, to the user equipment, an indication of the number of CSI measurement resources before the uplink resource configured for reporting the channel state metric.

Clause 20: The method of Clause 19, further comprising sending the indication via system information or RRC signaling.

Clause 21: The method of Clause 17, further comprising sending, to the user equipment, an indication of the subset of the one or more CSI measurement resources.

Clause 22: The method of Clause 21, further comprising sending the indication via RRC signaling or via one of layer 1 or layer 2 signaling.

Clause 23: The method of any one of Clauses 14-22, wherein: the CSI reference resource further indicates that time restriction for channel measurement is configured, and the channel state metric is based on the CSI-RS transmission power level and a latest CSI-RS measurement resource of the one or more CSI measurement resources.

Clause 24: The method of any one of Clauses 14-23, wherein the channel state metric comprises one or more of: a RSRP value; a RSRQ value; or a SINR value.

Clause 25: The method of any one of Clauses 14-24, further comprising performing one or more of the following based on the channel state metric: beam management; radio link failure detection; beam failure detection; time and frequency synchronization; or connected mode mobility.

Clause 26: One or more apparatuses, comprising: one or more memories comprising executable instructions; and one or more processors configured to execute the executable instructions and cause the one or more apparatuses to perform a method in accordance with any one of clauses 1-25.

Clause 27: One or more apparatuses, comprising means for performing a method in accordance with any one of clauses 1-25.

Clause 28: One or more non-transitory computer-readable media comprising executable instructions that, when executed by one or more processors of one or more apparatuses, cause the one or more apparatuses to perform a method in accordance with any one of clauses 1-25.

Clause 29: One or more computer program products embodied on one or more computer-readable storage media comprising code for performing a method in accordance with any one of clauses 1-25.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. A user equipment configured for wireless communications, comprising: one or more memories comprising processor-executable instructions; and one or more processors configured to execute the processor-executable instructions and cause the user equipment to:
receive a channel state information (CSI) reference resource indicating a CSI reference signal (CSI-RS) transmission power level;
receive one or more CSI measurement resources during an implicit indication interval beginning with the CSI reference resource and ending with an uplink resource configured for sending a channel state metric; and
determine the channel state metric based on the CSI-RS transmission power level and at least one of the one or more CSI measurement resources,
wherein the CSI reference resource implicitly indicates to the user equipment that the CSI-RS transmission power level applies to all of the one or more CSI measurement resources.

2. The user equipment of claim 1, wherein the CSI reference resource further indicates that time restriction for channel measurement is not configured.

3. The user equipment of claim 2, wherein the one or more processors are further configured to execute the processor-executable instructions and cause the user equipment to determine the channel state metric based on the CSI-RS transmission power level and each of the one or more CSI measurement resources.

4. The user equipment of claim 2, wherein the one or more processors are further configured to execute the processor-executable instructions and cause the user equipment to determine the channel state metric based on a subset of the one or more CSI measurement resources.

5. The user equipment of claim 4, wherein the subset comprises a number of CSI measurement resources before the uplink resource configured for reporting the channel state metric.

6. The user equipment of claim 5, wherein the one or more processors are further configured to execute the processor-executable instructions and cause the user equipment to receive an indication of the number of CSI measurement resources before the uplink resource configured for reporting the channel state metric.

7. The user equipment of claim 6, wherein the one or more processors are further configured to execute the processor-executable instructions and cause the user equipment to receive the indication via system information or radio resource control (RRC) signaling.

8. The user equipment of claim 4, wherein the one or more processors are further configured to execute the processor-executable instructions and cause the user equipment to receive an indication of the subset of the one or more CSI measurement resources.

9. The user equipment of claim 8, wherein the one or more processors are further configured to execute the processor-executable instructions and cause the user equipment to receive the indication via radio resource control (RRC) signaling or via one of layer 1 or layer 2 signaling.

10. The user equipment of claim 1, wherein:
the CSI reference resource further indicates that time restriction for channel measurement is configured, and
the one or more processors are further configured to execute the processor-executable instructions and cause the user equipment to determine the channel state metric based on the CSI-RS transmission power level and a latest CSI-RS measurement resource of the one or more CSI measurement resources.

11. The user equipment of claim 1, wherein the channel state metric comprises one or more of:
a reference signal received power (RSRP) value;
a reference signal received quality (RSRQ) value; or
a signal to interference and noise ratio (SINR) value.

12. The user equipment of claim 1, wherein the one or more processors are further configured to execute the processor-executable instructions and cause the user equipment to perform one or more of the following based on the channel state metric:
beam management;
radio link failure detection;
beam failure detection;
time and frequency synchronization; or
connected mode mobility.

13. The user equipment of claim 1, wherein the one or more processors are further configured to execute the processor-executable instructions and cause the user equipment to send, to a network entity via the uplink resource, the channel state metric.

14. A method for wireless communications by a user equipment, comprising:
receiving a first channel state information (CSI) reference resource indicating a CSI reference signal (CSI-RS) transmission power level;
receiving one or more CSI measurement resources during an implicit indication interval beginning with the CSI reference resource and ending with an uplink resource configured for sending a channel state metric; and
determining the channel state metric based on the CSI-RS transmission power level and at least one of the one or more CSI measurement resources.

15. A network entity configured for wireless communications, comprising: one or more memories comprising processor-executable instructions; and one or more processors configured to execute the processor-executable instructions and cause the network entity to:
send, to a user equipment, a channel state information (CSI) reference resource indicating a CSI reference signal (CSI-RS) transmission power level;
send, to the user equipment, one or more CSI measurement resources during an implicit indication interval beginning with the CSI reference resource and ending with an uplink resource configured for receiving a channel state metric; and
receive, from the user equipment, the channel state metric,
wherein the CSI reference resource is configured to implicitly indicate to the user equipment that the CSI-RS transmission power level applies to all of the one or more CSI measurement resources.

16. The network entity of claim 15, wherein the CSI reference resource further indicates that time restriction for channel measurement is not configured.

17. The network entity of claim 16, wherein the channel state metric is based on the CSI-RS transmission power level and each of the one or more CSI measurement resources.

18. The network entity of claim 16, wherein the channel state metric is based on a subset of the one or more CSI measurement resources.

19. The network entity of claim 18, wherein the subset comprises a number of CSI measurement resources before the uplink resource configured for reporting the channel state metric.

20. The network entity of claim 19, wherein the one or more processors are further configured to execute the processor-executable instructions and cause the network entity to send, to the user equipment, an indication of the number of CSI measurement resources before the uplink resource configured for reporting the channel state metric.

21. The network entity of claim 20, wherein the one or more processors are further configured to execute the processor-executable instructions and cause the network entity to send the indication via system information or radio resource control (RRC) signaling.

22. The network entity of claim 18, wherein the one or more processors are further configured to execute the processor-executable instructions and cause the network entity to send, to the user equipment, an indication of the subset of the one or more CSI measurement resources.

23. The network entity of claim 22, wherein the one or more processors are further configured to execute the processor-executable instructions and cause the network entity to send the indication via radio resource control (RRC) signaling or via one of layer 1 or layer 2 signaling.

24. The network entity of claim 15, wherein:
the CSI reference resource further indicates that time restriction for channel measurement is configured, and
the channel state metric is based on the CSI-RS transmission power level and a latest CSI-RS measurement resource of the one or more CSI measurement resources.

25. The network entity of claim 15, wherein the channel state metric comprises one or more of:
a reference signal received power (RSRP) value;
a reference signal received quality (RSRQ) value; or
a signal to interference and noise ratio (SINR) value.

26. The network entity of claim 15, wherein the one or more processors are further configured to execute the processor-executable instructions and cause the network entity to perform one or more of the following based on the channel state metric:
beam management;
radio link failure detection;
beam failure detection;
time and frequency synchronization; or
connected mode mobility.

27. A method for wireless communications by a network entity, comprising:
sending, to a user equipment, a first channel state information (CSI) reference resource indicating a CSI reference signal (CSI-RS) transmission power level;
sending, to the user equipment, one or more CSI measurement resources during an implicit indication interval beginning with the CSI reference resource and ending with an uplink resource configured for receiving a channel state metric; and
receiving, from the user equipment via the uplink resource, the channel state metric,
wherein the CSI reference resource is configured to implicitly indicate to the user equipment that the CSI-RS transmission power level applies to all of the one or more CSI measurement resources.
